(19) United States
(12) Patent Application Publication
(10) Pub. No.: US 2005/0254817 A1
(43) Pub. Date: Nov. 17, 2005

(54) Autostereoscopic electronic camera

(76) Inventor: William James McKee, Tiburon, CA (US)

Correspondence Address: WILLIAM J. MCKEE, JR., 311 PARADISE DRIVE, TIBURON, CA, 94900-2536, US

(21) Appl. No.: 10/843,878

(22) Filed: May 13, 2004

(51) Int. Cl. G03B 7/099

(52) U.S. Cl. 396/544

(57) ABSTRACT

The Electronic Autostereoscopic Camera comprises a taking “lens” that gathers full scene information and encodes this information onto the camera electronic sensor such that the “Depth” of the scene constituents is thereby preserved. This camera may be of a monochrome, single sensor color, or multi-sensor color type and may utilize C.C.D., Analog, C.M.O.S., or other variety of photosensitive electronic sensor. The output information from the camera may be in any suitable format suitable for use in the C.C.T.V., Broadcast T.V., or A/V displays (Computer Generated). Post processing and recording of the data is handled in the same manner as the familiar Two-Dimensional content now utilized by such industries and users. The “lens” of this camera may be configured to function on other electronic cameras by fitting the scene “Depth Encoding” optical group to a particular camera as may be desired by the user. These cameras may include Simple Hand Held, Shoulder Mounted, Tripod Mounted, Laboratory, Studio, or Vehicle Mounted models of various design and manufacture.

### CROSS REFERENCE TO RELATED APPLICATIONS

This application refers to the preliminary patent application posted on May 10, 2003 entitled “AUTOSTEREOSCOPIC ELECTRONIC CAMERA, and refers to the disclosure document filed on May 31, 2002 entitled “ELECTRONIC THREE DIMENSIONAL PANORAMIC IMAGING SYSTEM”, holding the document disclosure No. 512247 from the USPTO disclosure document program.

### FEDERALLY SPONSORED RESEARCH OR DEVELOPMENT

Not Applicable

### REFERENCE TO A MICROFICHE APPENDIX

Not Applicable

### BACKGROUND OF THE INVENTION

The field of three dimensional imaging has a long road of research and development throughout several centuries. Since we, as humans, exist in a three dimensional world it is a natural desire to view displays in depth just as if we were viewing it directly. Within the past two decades a number of different scientific, academic, and commercial entities have been pursuing the field of “Autostereoscopic” displays; one that precludes the need for additional glasses placed on the viewers head in order to successfully view the depth information. One of the main drawbacks in the successful proliferation of three dimensional imaging has always been the creation of satisfactory content to display. Numerous artists, film makers, graphic artists and photographers have attempted to deal with this problem with varying levels of success in each area. None have proven to be highly satisfactory while the process remains an expensive and labor intensive undertaking.

In the area of autostereoscopic imaging there are two major schools of approach to the display technology, the first comprises a 2-Image system wherein the user must be fitted with a head tracking device that will adjust the display to accommodate the users' position in the viewing area. The second approach is that of an electronic display of the “Parallax Panoramagram” that has been used for years in the film medium.

### BRIEF SUMMARY OF THE INVENTION

This camera invention provides a single sensor system capable of producing a true autostereoscopic capture of the scene information with a single optical system. The idea for this camera, in part, derives from the inventor's prior work on film type cameras using the parallax panoramagram technology, U.S. Pat. No. 4,487,490. There have been camera systems with a multiplicity of lenses and multiple cameras with a single segmented optical system. The desire to have a single sensor, or alternatively, a single camera with the R-G-B color sensors of a three sensor color camera acting in unison, capture a single image from a continuum of viewing angles is paramount to the successful unrestrained growth, so long awaited, in the industry. The value is dependant upon the optical encoding technique employed by the use of the well known technology of the lenticular screen, an optical array with a parallel grouping of cylindrical lenses side-by-side and acting as optical angulation discriminators and dutifully directing the incoming light rays to the appropriate location for subsequent capture and display; or alternatively an optical ruling grating providing the same function. The image focused upon the electronic sensor is now encoded with the optical information being directed to the sensor dependant upon the input angle. Upon subsequent optical “decoding” and displaying, will provide an image to the observer that contains the depth relationships of the scene viewed by the camera.

### BRIEF DESCRIPTION OF THE SEVERAL VIEWS OF THE DRAWINGS

FIG. 1a The optical system schematic utilizing a lenticular lens array

FIG. 1b The optical system schematic utilizing an optical ruling grating

FIG. 2a The “taking” lens-to-image plane detail using a lenticular lens array

FIG. 2b The “taking” lens-to-image plane detail using an optical ruling grating

FIG. 3a The round lens with mask

FIG. 3b The rectangular lens without mask

FIG. 4a The lenticular lens array rotational stage

FIG. 4b The optical ruling grating rotational stage

FIG. 5 The optical encoded data relationship to the sensor(s)

FIG. 6a The optical system, encoding on the focal plane using a lenticular lens array

FIG. 6b The optical system, encoding on the focal plane using an optical ruling grating

FIG. 7a The optical system, focal plane to sensor(s) utilizing a lenticular lens array

FIG. 7b The optical system lenticular array directly at the sensor(s)

FIG. 8a The optical system, focal plane to sensor(s) utilizing an optical ruling grating

FIG. 8b The optical system optical ruling grating directly at the sensor(s)

### DETAILED DESCRIPTION OF THE INVENTION

The invention is a camera based on electronic imaging technology that has been configured with an optical system that encodes the scene information into a complex proprietary image format that may be output in a “standard” timing format common in the industry. The camera may have any of a variety of output format signals such as R-G-B, NTSC, PAL, CCIR, 1080p, 720i, DVI, Y/C, Sony Component, “S-Video”, RS-170, RS-330, as well as other international, European or Asian format.

The camera may be of the closed circuit video camera, digital snapshot camera, professional level studio video camera, or other similar camera types employing a single image sensor or a group of sensors such as the three Red-Green-Blue channels acting together as one. For simplicity of explanation, the remainder of the text will use the singular sensor as the example with the understanding that this does not exclude the R-G-B trio of sensors that act as a single sensor in the imaging pickup of typical color cameras. The sensor may be of the size more commonly found in consumer and closed circuit type cameras but may also be of a large area variety with significantly larger proportions and include even higher resolution applications. It may be of the Analog (non-matrix photosensitive layer) type, Charge Coupled Device (CCD), Complementary Metal Oxide Semiconductor (CMOS), amorphous material, or other type of sensor used to detect an image formed with light on an image plane. Light in this reference is intended to include all wavelengths from the ultraviolet through the infrared spectrum, not limited to just the “photopic” spectrum.

The camera may be of the variety used for either color or monochrome imaging applications. The color scheme can be of the Red-Green-Blue, Bayer, Sony Complementary, or other color scheme as may be used for a particular sensor. The camera sensor resolution or readout scheme used is not the consideration for the application of the technology. The primary consideration is the function of the optical encoding technique employed in order to generate a single sensor stereoscopic information “map” on the sensor by the optical system employed to that purpose.

The optical system can be of a “C” mount, “CS” mount, Bayonet type mount, Threaded Mount, or any of the commonly used optical mounting schemes for camera serving particular applications. The optical system may also be built in to the housing of the camera as may be suitable for many configurations envisioned.

The optical system of this camera can be adapted to other cameras as an “add-on” thereby enlarging the utility of the design and making it available to those owners of video or digital cameras that wish to take three dimensional images in lieu of the normal two dimensional ones for which their camera was originally designed. The addition of this optical system will require an alternative camera lens action that may require a change in the lensing or operation of the lens functions in order to assure the proper size of image and sharpness of focus. The electronic zoom function on such cameras, if fitted, will still be functional.

The optical system may be designed to be used interchangeably with a variety of particular electronic camera modules as one may wish depending on the application being addressed at any given time.

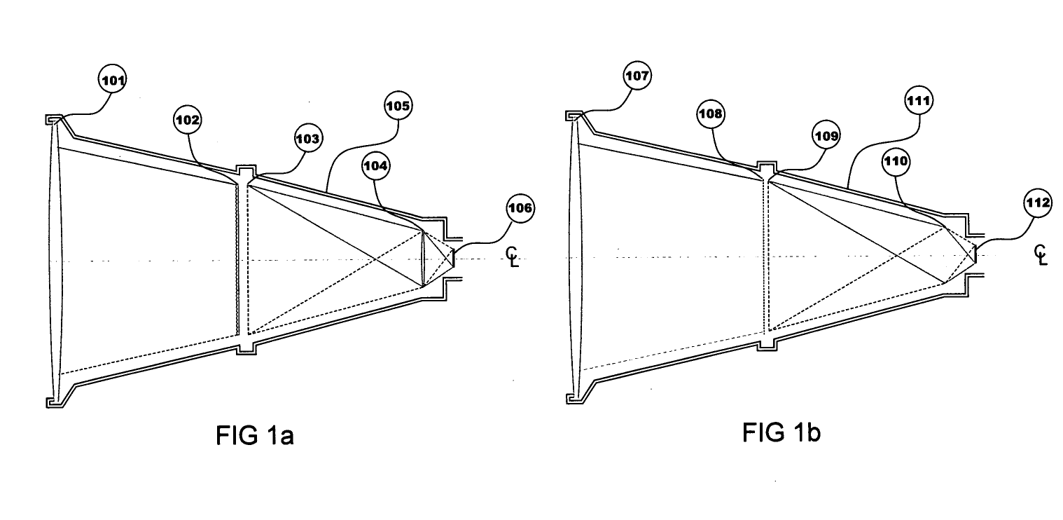

Referring to FIG. 1a, the optical system comprises: the initial taking objective optic (101), the imaging lenticular array (102), the primary image focal plane (103) the intermediate imaging objective optic (104) the mechanical structure to house and operate the aforementioned component parts as well as mount to the camera (105), and the image sensor (106). The lenses are shown as simple lenses for clarity and ease of understanding; the actual lenses may be of a compound design typical of modern computer optimized lenses.

Referring to FIG. 1b, the optical system comprises: the initial taking objective optic (101), the imaging the optical ruling grating (108), the primary image focal plane (109) the intermediate imaging objective optic (110) the mechanical structure to house and operate the aforementioned component parts as well as mount to the camera (111), and the image sensor (112). The lenses are shown as simple lenses for clarity and ease of understanding; the actual lenses may be of a compound design typical of modern computer optimized lenses.

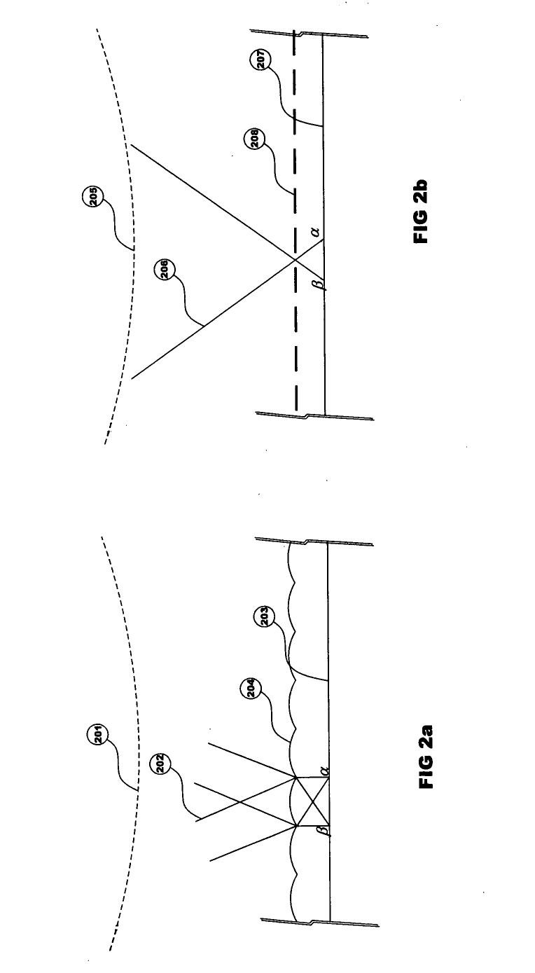

Referring to FIG. 2a, the camera with optical system is comprises the following: The “Taking” lens (201) is viewing a scene that the user wishes to observe. The light output of the taking lens (202) is then focused upon the image focal plane (203) through the lenticular array (204), interposed immediately before the focal plane. The output of the taking lens, having an exit cone of light focusing some distance away as determined by the focal length and the “width” of the taking lens rearmost element. The term “width” is used here in place of “diameter” commonly associated with taking objectives to indicate that the lens may be, but need not be, configured in a “round” physical form.

Referring to FIG. 2b, the camera with optical system is comprises the following: The “Taking” lens (205) is viewing a scene that the user wishes to observe. The light output of the taking lens (206) is then focused upon the image focal plane (207) through the optical ruling grating)(208), interposed immediately before the focal plane. The output of the taking lens, having an exit cone of light focusing some distance away as determined by the focal length and the “width” of the taking lens rearmost element. The term “width” is used here in place of “diameter” commonly associated with taking objectives to indicate that the lens may be, but need not be, configured in a “round” physical form.

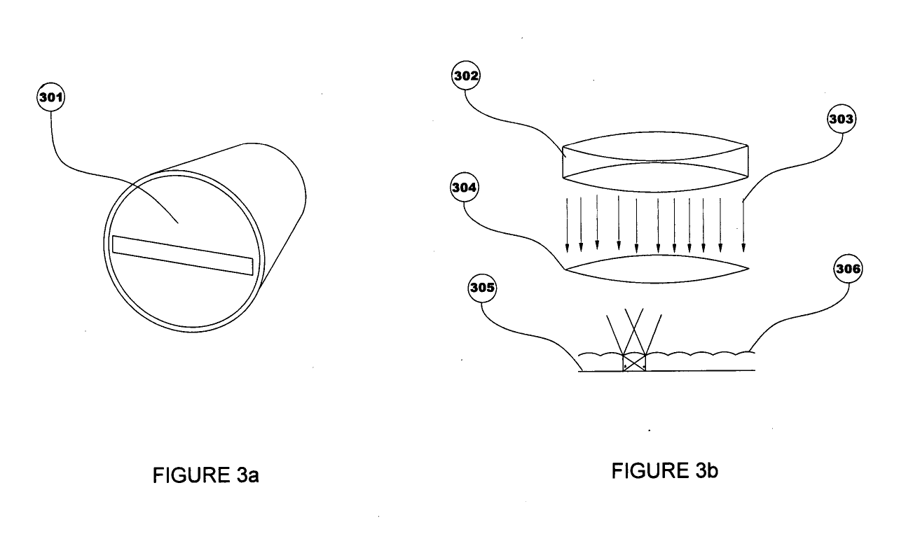

Referring to FIG. 3a, the taking lens that includes a “mask” (301) fitted across the front of the lens if of a typical cylindrical design.

Referring to FIG. 3b, the preferred embodiment of the taking optic is made with an appearance of a lens made in an anamorphic aspect ratio so as to provide the necessary width of image taking parallax with a minimum of vertical component structure. The taking lens has a focusing group of elements (302) used to focus on the scene being observed, whose output is a bundle of information (303) as if from a source a distance away. The output element group of the taking optic (304) then focuses this parallel bundle of light information in order to form an image on the image focal plane (305) through the lenticular array (306).

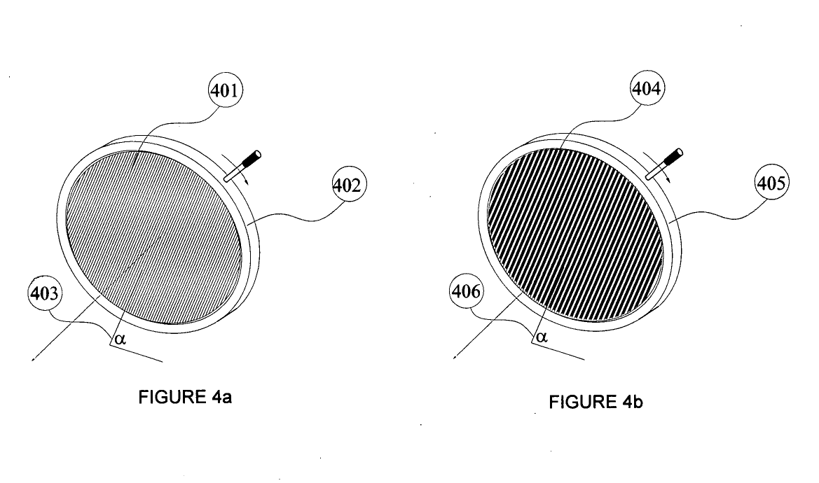

Referring to FIG. 4a, the lenticular array (401) is mounted on a rotational stage (402) whereby the user can precisely match a “slant” (403) that may be characteristic of a particular image output device used to view the output information content in three dimensional relief.

Referring to FIG. 4b, the optical ruling grating (404) is mounted on a rotational stage (405) whereby the user can precisely match a “slant” (406) that may be characteristic of a particular image output device used to view the output information content in three dimensional relief.

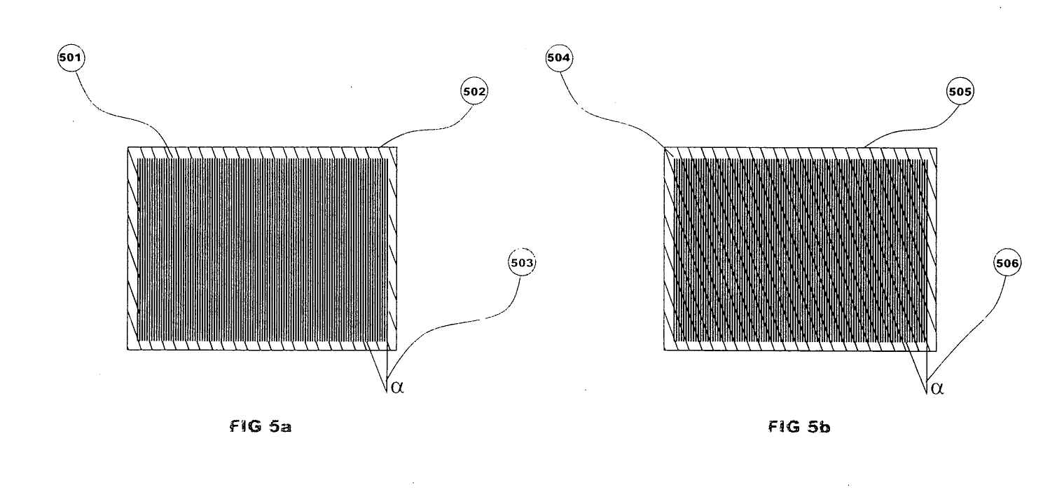

Referring to FIG. 5a the lenticular array acceptance angle is matched to the output taking lens in that the full width of the lens output will “fill” the full width of the focal plane. This figure shows an example of the camera sensor matrix (501) that is overlaid with the image information that may be thought of as “stripes” of image content (502), from a group of lenticules which reside immediately before the intermediate image focal plane. The pitch of the image “stripes” as well as the angle of rotation (503) may be adjusted to match a particular type and model of display device for which the camera is being used.

Referring to FIG. 5b, the optical ruling grating acceptance angle is matched to the output taking lens in that the full width of the lens output will “fill” the full width of the focal plane. This figure shows an example of the camera sensor matrix (504) that is overlaid with the image information that may be thought of as “stripes” of image content (505), from a group of lenticules which reside immediately before the intermediate image focal plane. The pitch of the image “stripes” as well as the angle of rotation (506) may be adjusted to match a particular type and model of display device for which the camera is being used.

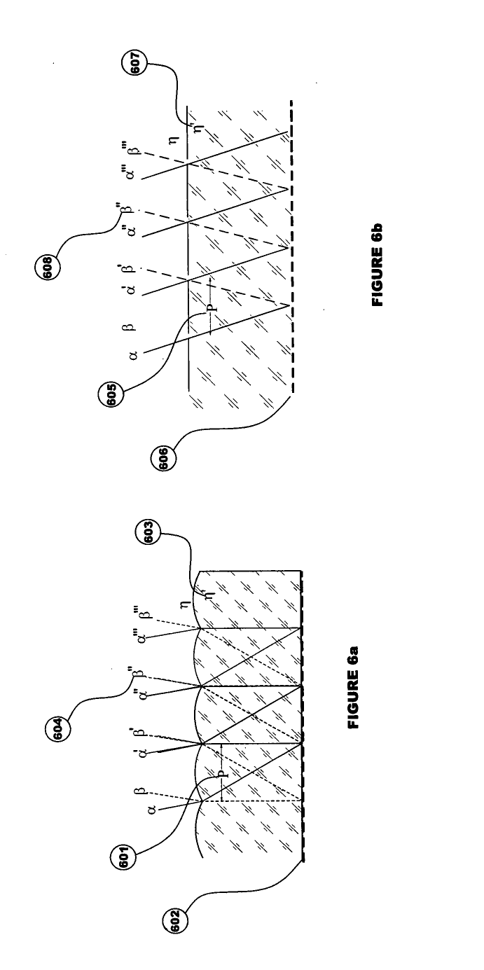

Referring to FIG. 6a, the typical optical encoding results are shown. The transition of the image information through the lenticular array acts to encode the image information that is focused on the image focal plane. The encoding is a result of the pitch of the lenticular array (601), the distance from the lenticular array to the focal plane (602), the index of refraction of the material used to fabricate the lenticular array (603), and the angle at which the information is being received from the “taking” optic (604). The encoding of image information in this manner, to this end is essential to this particular type of optical/camera system.

Referring to FIG. 6b, the typical optical encoding results are shown. The transition of the image information through the optical ruling grating acts to encode the image information that is focused on the image focal plane. The encoding is a result of the pitch of the optical ruling grating (605), the distance from the optical ruling grating to the focal plane (606), the index of refraction of the material upon which the optical ruling grating is fabricated (607), and the angle at which the information is being received from the “taking” optic (608). The encoding of image information in this manner, to this end is essential to this particular type of optical/camera system.

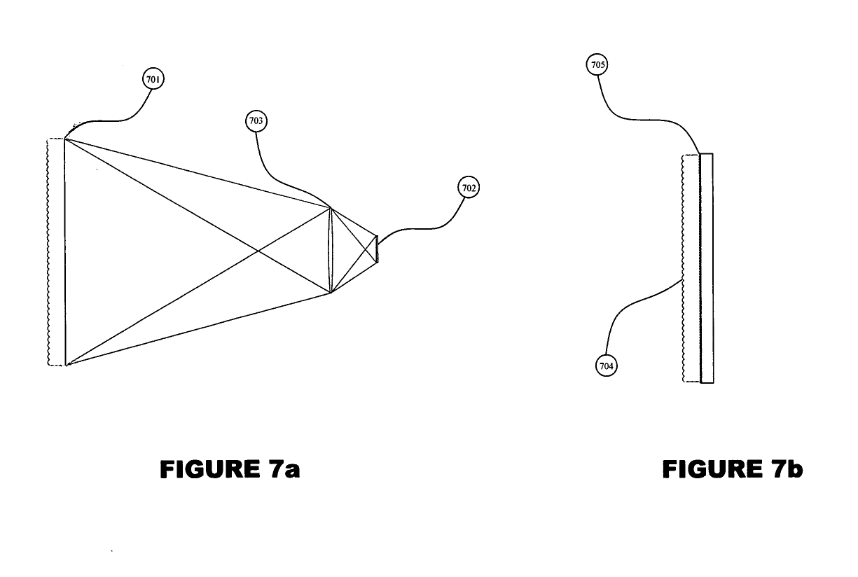

Referring to FIG. 7a, the image now located at the intermediate image plane (701) is optically transferred to the image sensor (702) of the camera by the intermediate imaging objective optic (703). The function of this optic is two-fold: the first function is to provide an optical magnification factor required by the camera in conjunction with the particular display being used. This is accomplished by the simultaneous movement of the intermediate objective and the image sensor; secondly, to focus the image onto the image sensor of the camera. This is accomplished by the movement of the image sensor with respect to the intermediate objective optic. These two functions are inherently interdependent and must be optimized via an iterative process. This optimization is required only once during the initial optical system/lens setup procedure and will remain fixed with those settings unless the user wished to change them.

Referring to FIG. 7b, the use of an intermediate focal plane with the associated intermediate objective optic may be precluded if the lenticular array (704) is fabricated of a size to fit immediately on the front of the image sensor (705) in close juxtaposition and focus the image information thereon. This then will encode the information directly onto the sensor in a similar manner to that of the intermediate imaging plane had been used. It is noted here that this lenticular array to sensor fabrication would be carried out in triplicate if the camera is a three sensor color configuration.

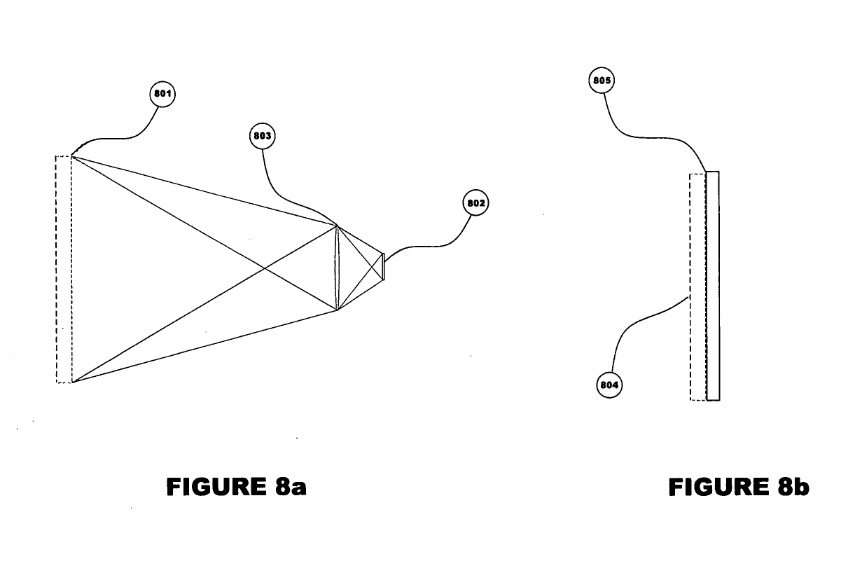

Referring to FIG. 8a, the image now located at the intermediate image plane (801) is optically transferred to the image sensor (802) of the camera by the intermediate imaging objective optic (803). The function of this optic is two-fold: the first function is to provide an optical magnification factor required by the camera in conjunction with the particular display being used. This is accomplished by the simultaneous movement of the intermediate objective and the image sensor; secondly, to focus the image onto the image sensor of the camera. This is accomplished by the movement of the image sensor with respect to the intermediate objective optic. These two functions are inherently interdependent and must be optimized via an iterative process. This optimization is required only once during the initial optical system/lens setup procedure and will remain fixed with those settings unless the user wished to change them.

Referring to FIG. 8b the use of an intermediate focal plane with the associated intermediate objective optic may be precluded if the optical ruling grating (804) is fabricated of a size to fit immediately on the front of the image sensor (805) in close juxtaposition and distribute the image information thereon. This then will encode the information directly onto the sensor in a similar manner to that of the intermediate imaging plane had been used. It is noted here that this optical ruling grating to sensor fabrication would be carried out in triplicate if the camera is a three sensor color configuration.

The camera sensor is driven electronically and the output signal utilized in a manner well known in the field of electronic and digital cameras and is not the subject of this patent. Further description is therefore not given herein.

The resultant output image information is the optically encoded scene information that may now be handled in a manner normal for typical image content with respect to recording, manipulation, compression, signal processing, editing, as well as transmission via commonly available commercial transmission systems such as satellite, broadcast television, digital cable, analog cable, closed circuit systems, and the like. Such “post-Processing” is well known in the industry and, not being the subject of this patent, is not described further herein.

Since the image information, thus encoded, comprises the same amount of data as present “standard” broadcast television; there is no need to await the new HDTV or alternative transmission standards and equipment in order to utilize the information throughout the entire broadcasting industry. This is intended to immediately enable the television broadcast industry for industrial, commercial, and closed circuit applications as if it were a normal “two-dimensional content” video signal. The transmission format and synchronizing signal can be configured in accordance with the normal television and video standards, and this patent refers to the Federal Communications Commission, the National Association of Broadcasters as well as other “standards” of organizations, both domestic and abroad, for their particular signal characteristics.

1. A camera with an optical encoding means that is physically a part of the taking optical components.

2. A camera as in item “1” whose encoding means is a micro-lens array.

3. A camera as in item “1” above whose encoding means is an optical grid structure.

4. A camera with an optical encoding means that is in close juxtaposition to the sensor matrix.

5. A camera as in item “4” above whose encoding means is a micro-lens array.

6. A camera as in item “4” above whose encoding means is an optical grid structure.

7. A display device whose optical decoding means is a removable micro-lens array.

8. A display device whose optical decoding means is a removable optical grid structure.

9. An optical system containing an optical encoding means, which system can be fitted to an existing camera to enable the “taking” of three-dimensional, optically encoded, scene information.
